(19) United States
(12) Patent Application Publication
(10) Pub. No.: US 2006/0141865 A1
(43) Pub. Date: Jun. 29, 2006

(54) Combo-type male and female universal series bus connector

(75) Inventors: Steel Su, Taipei (TW); Toon Jeow Foo, Taipei (TW)

Correspondence Address: G. LINK CO., LTD, 3550 Bell Road, Minooka, IL, 60447, US

(73) Assignee: BEHAVIOR TECH COMPUTER CORP.

(21) Appl. No.: 11/021,862

(22) Filed: Dec. 27, 2004

(51) Int. Cl. H01R 13/648

(52) U.S. Cl. 439/607

(57) ABSTRACT

The present invention is a combo-type male and female universal series bus (USB) connector which is characterized in that either the USB metallic shell or the electrically connecting terminal board is movable to expose or shield a plurality of electrically connecting terminals attached to the electrically connecting terminal board. When the electrically connecting terminals are completely exposed, the USB connector acts as a male USB connector, and when the electrically connecting terminals are shielded, the USB connector acts as a female USB connector.

### FIELD OF THE INVENTION

The present invention is related to a universal series bus (USB) connector, especially to a combo-type male and female USB connector.

### BACKGROUND OF THE INVENTION

A kind of the conventional USB connector with functions of a male and a female connectors is a cable with an end thereof being soldered with a male connecting socket and the other end thereof being soldered a female connecting socket. Another kind of the conventional USB connector including both the male connecting socket and female connecting socket, which are electrically connected to each other, are wrapped with an insulator respectively. Since the conventional USB connector with functions of a male and a female connectors provides individual male connecting socket and female connecting socket, it obviously fails to reduce the integral size thereof.

The inventors have investigated the above shortcomings and developed a combo-type male and female USB connector, which combines the functions of the male connecting socket and the female connecting socket into a single piece of USB connector.

### SUMMARY OF THE INVENTION

The main object of the present invention is to provide a combo-type male and female USB connector.

To achieve the above object, the present invention provides a combo-type male and female USB connector, which includes a wrap piece, a metallic shell with the first end thereof being a free end and the second end thereof being placed in the wrap piece and an electrically connecting terminal board attached with a plurality of terminals with an end thereof being placed in the wrap piece and another end thereof being located at the first end of the metallic shell. It is characterized in that the metallic shell is movable relative to the electrically connecting terminal board such that the metallic shell capable of being moved to expose the electrically connecting terminals completely for the USB connector acting as a male USB connector and it is capable of being moved to shield the electrically connecting terminals for the USB connector acting as a female USB connector.

### BRIEF DESCRIPTION OF THE DRAWINGS

The above objects and advantages of the present invention will become more apparent with reference to the appended drawings wherein:

FIG. 1 is a plan view showing the structural of the USB connector of the present invention;

FIG. 2A is a perspective view showing the first embodiment of the USB connector according to the structure of FIG. 1;

FIG. 2B is a perspective view illustrating the metallic shell of the USB connector shown in FIG. 2A being movable;

FIG. 2C is a perspective view illustrating the metallic shell being retracted and the electrically connecting terminals on an electrically connecting terminal board being exposed completely to act as a male USB connector;

FIG. 3A is a perspective view showing the second embodiment of the USB connector according to the structure FIG. 1;

FIG. 3B is a perspective view illustrating the metallic shell of the USB connector shown in FIG. 3A being movable with arrangement of sliding operation;

FIG. 3C is a perspective view illustrating the metallic shell being retracted and the electrically connecting terminals on an electrically connecting terminal board being exposed completely to act as a male USB connector;

FIG. 4A is a perspective view showing the third embodiment of the presently invented USB connector according to the structure of FIG. 1;

FIG. 4B is a perspective view illustrating the electrically connecting terminal board of the USB connector shown in FIG. 4A being movable with arrangement of sliding operation;

FIG. 4C is a perspective view illustrating the electrically connecting terminal board being moved forward and the electrically connecting terminals on an electrically connecting terminal board being exposed completely to act as a male USB connector;

FIG. 5A is a perspective view showing the fourth embodiment of the USB connector according to the structure of FIG. 1;

FIG. 5B is a perspective view illustrating the metallic shell half of the USB connector of FIG. 5A being pivotally movable;

FIG. 5C is a perspective view illustrating the metallic shell being pivotally moved to the upright position and the electrically connecting terminals on an electrically connecting terminal board being exposed completely to act as a male USB connector;

FIG. 6A is a perspective view showing the fifth embodiment of the presently invented USB connector according to the structure of FIG. 1;

FIG. 6B is a perspective view illustrating the metallic shell halves of the USB connector of FIG. 6A being pivotally movable;

FIG. 6C is a perspective view illustrating the metallic shell halves being pivotally moved laterally to a cross position with the electrically connecting terminal board and the electrically connecting terminals on an electrically connecting terminal board being exposed completely to act as a male USB connector;

FIG. 7 is a perspective view showing the first embodiment of the adapter of the presently invented USB connector; and

FIG. 8 is a perspective view showing the second embodiment of the adapter of the presently invented USB connector.

### DETAILED DESCRIPTION OF THE INVENTION

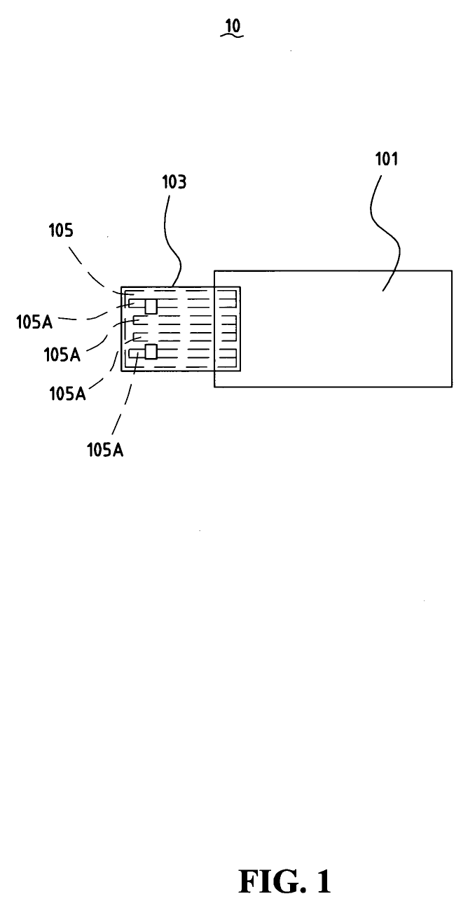

FIG. 1 shows the structural of the presently invented USB connector. The USB connector 10 is a combo-type male and female USB connector and the user is able to operate the metallic shell 103 or the electrically connecting terminal board 105 to expose a plurality of electrically connecting terminals 105A, which are originally shielded by the metallic shell 103. The USB connector 10 mainly comprises a wrap piece 101, a metallic shell 103 and an electrically connecting terminal board 105. Warp piece 101 is manufactured by insulating material like plastics. The first end of the metallic shell 103 is free and the second end is placed in wrap piece 101. Electrically connecting terminal board 105 is attached with the electrically connecting terminals 105A. An end of electrically connecting terminal board 105 is placed in wrap piece 101 and another end of the electrically connecting terminal board 105 is located at the free end of metallic shell 103. The USB connector 10 is mainly characterized in that metallic shell 103 is movable relative to the electrically connecting terminal board 105 such that when metallic shell 103 or the electrically connecting terminal board 105 is operated by the user to expose the electrically connecting terminals 105A completely, USB connector 10 acts as a male USB connector and when metallic shell 103 is operated by the user, the electrically connecting terminals 105A are shielded in metallic shell 103 to make USB connector 10 be the female USE connector.

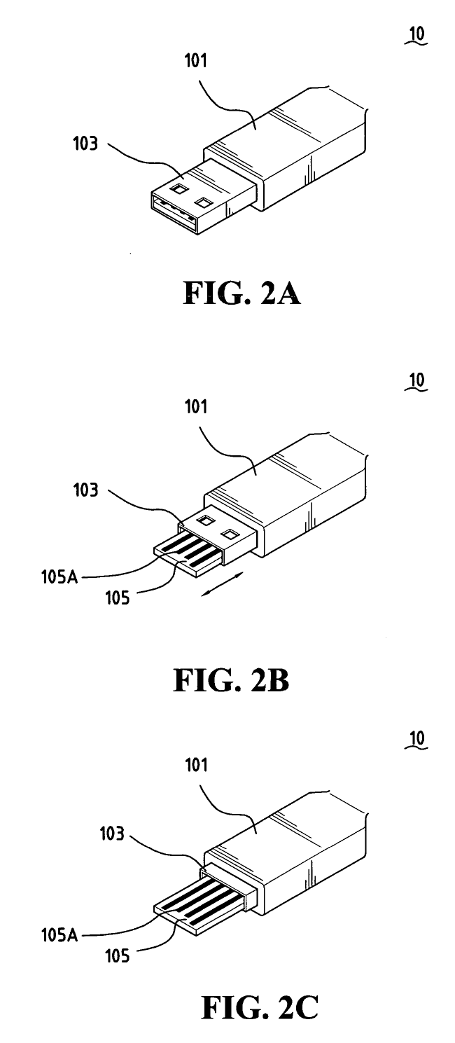

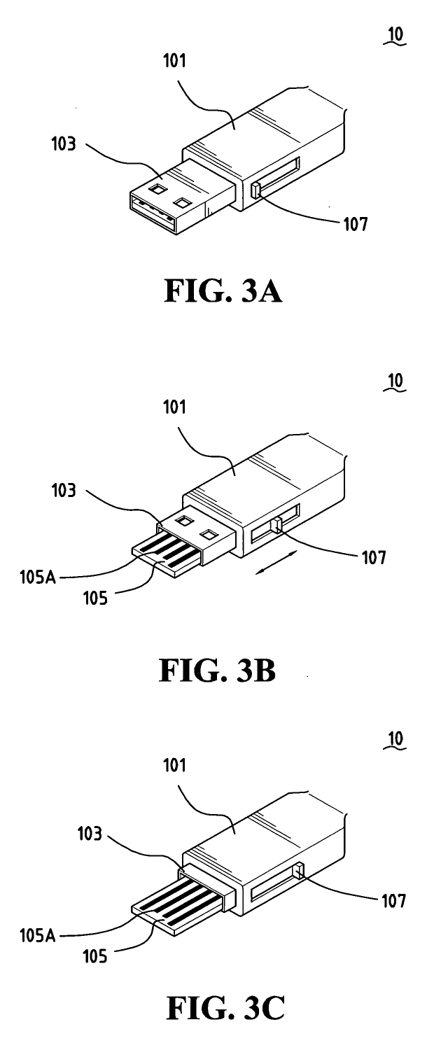

FIGS. 2A, 2B and 2C show the first embodiment of the USB connector according to the present invention. FIG. 2A illustrates the USB connector 10 acts as the female USB connector. FIG. 2B illustrates the metallic shell 103 is movable and has been moved toward inside the wrap piece 101 against an elastic force provided by an elastic device (not shown) in the wrap piece 101. FIG. 3C illustrates the metallic shell 103 enters inside wrap piece 101 to expose the electrically connecting terminals 105A on the electrically connecting terminal board 105 such that the USB connector 10 then acts as a male USB connector.

FIGS. 3A, 3B and 3C show the second embodiment of the USB connector according to the present invention The USB connector 10 in the second embodiment provides a sliding piece 107 which is placed in a guide groove at a sidewall of the wrap piece 101 for moving the metallic shell 105. FIG. 3A illustrates the USB connector 10 acts as the female USB connector. FIG. 3a illustrates the metallic shell 103 is movable by means of the sliding piece 107 being moved to slide along the guide groove. It can be seen that the metallic shell 103 moves backward along with the sliding piece 107 sliding backward along the guide groove. FIG. 3C illustrates the metallic shell 103 has entered inside the wrap piece 101 to expose the electrically connecting terminals 105A on the electrically connecting terminal board 105 such that the USB connector 10 then acts as a male USB connector.

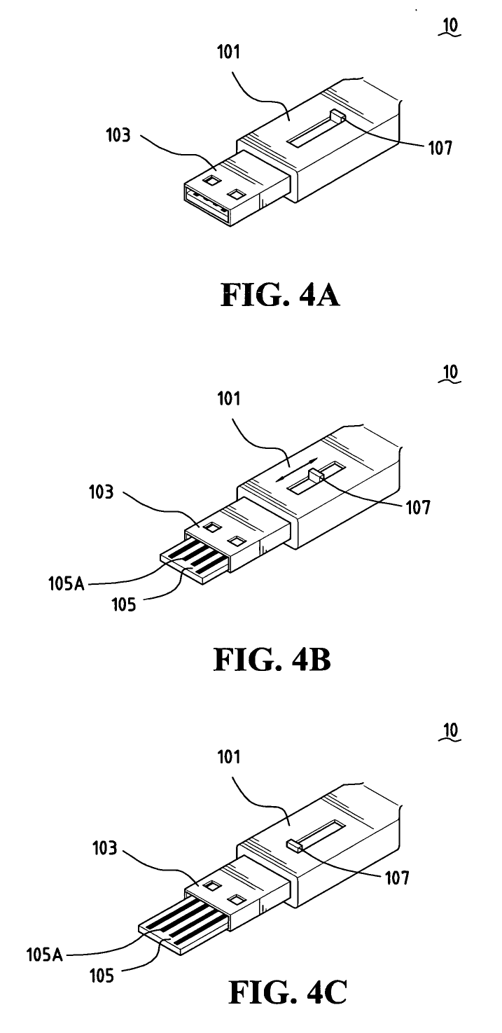

FIGS. 4A, 4B and 4C show the third embodiment of the USB connector according to the present invention. The USB connector 10 further provides a sliding piece 107 which is placed in a guide groove at the top wall of wrap piece 101 or the bottom wall of the wrap piece 101 (not shown) for moving the electrically connecting terminal board 105. FIG. 4A illustrates the USB connector 10 acts as a female-type USB connector. FIG. 4B illustrates the electrically connecting terminal board is movable once the sliding piece 107 is moved along the guide groove. FIG. 4C illustrates the electrically connecting terminal board 105 is moved outward the metallic shell 103 to expose the electrically connecting terminals 105A such that the USB connector 10 then acts as a male USB connector.

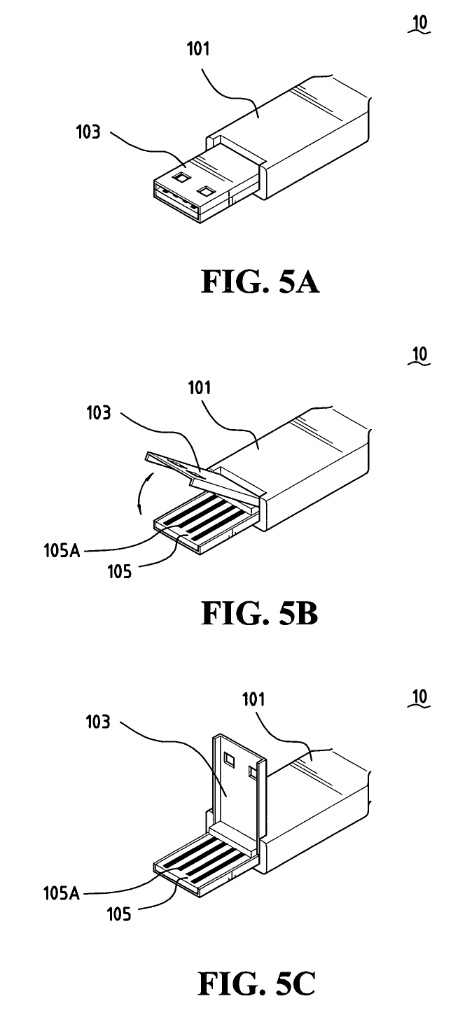

FIGS. 5A, 5B and 5C show the fourth embodiment of the USB connector according to the present invention. FIG. 5A illustrates the USB connector 10 acts as the female USB connector. The metallic shell 103 is composed of two metallic shell halves and the second end of one of the metallic shell halves is pivotally connected to the front end of the wrap piece 101 with a recess at the front end of the wrap piece 101 corresponding to the metallic shell half FIG. 5B illustrates the metallic shell half is rotationally movable with respect to the front end of the wrap piece 101. FIG. 5C illustrates the metallic shell half is moved to a position perpendicular to the electrically connecting terminal board 105 with the second end thereof being disposed in the recess at the front end of the wrap piece 101 to expose the electrically connecting terminal 105A on the electrically connecting terminal board 105 completely such that the USB connector 10 then acts as the nude USB connector.

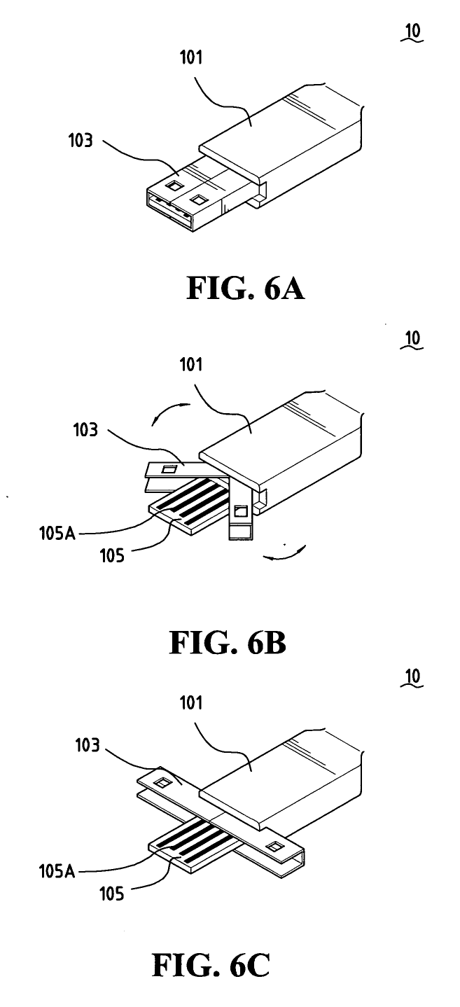

FIGS. 6A, 6B and 6C show the fifth embodiment of the USB connector according to the present invention. FIG. 6A illustrates the USB connector 10 acts as the female USB connector. The metallic shell 103 is composed of two metallic shell halves and the second end of each of the metallic shell halves is pivotally connected to the front end of the wrap piece 101 with a recess provided at the front end of the wrap pieces corresponding to the metallic shell halves. FIG. 6B illustrates the metallic shell halves are rotationally movable with respect to the front end of the wrap piece 101. FIG. 6C illustrates the metallic shell halves are moved leftward and rightward respectively to a position perpendicular to the electrically connecting terminal board 105 with the second ends of the metallic shell halves butting to each other and part of the outer lateral sides of the metallic shell halves being disposed in the recess at the front end of the wrap piece 101 to expose the electrically connecting terminal 105A on the electrically connecting terminal board 105 completely such that the USB connector 10 then acts as the male USB connector.

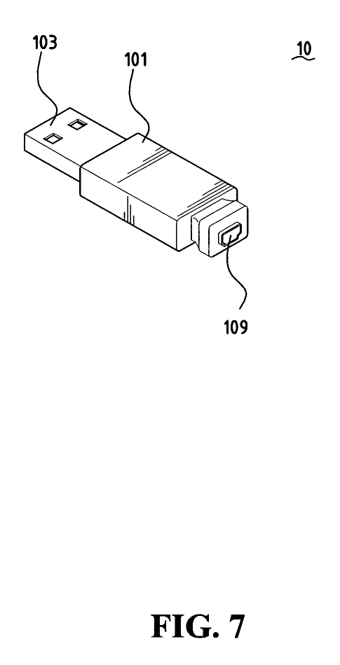

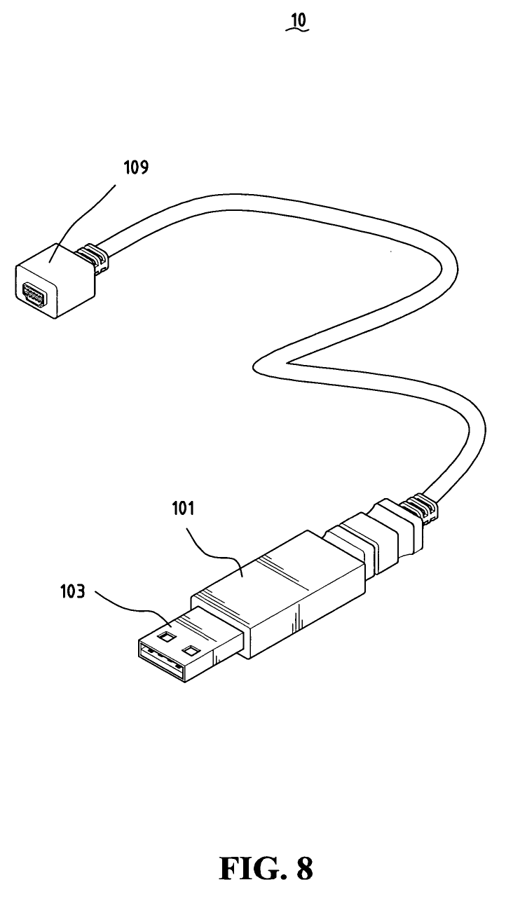

Referring to FIGS. 7 and 8, the USB connector 10 of the present invention further provides an adapter 109 for different specifications. FIG. 7 shows the adapter 109 is directly placed at the rear end of the wrap piece 101. FIG. 8 shows the adapter 109 is attached to another end of a cable which connects with the USB connector.

The combo-type male and female USB connector of the present invention possesses the following merits and benefits:

1. The USB connector of the present invention is capable of being either a female USB connector or a male USB connector as needed and the size thereof is reduced enormously.

2. The USB connector of the present invention is capable of being equipped with portable electronics like Pen Drive, Wireless Receiver, MP3 Player, MPEG4 Player, Photo Bank, Mobile Phone, Digital Camera and so on, to enhance USB connectivity for these products.

Although the present invention has been disclosed one embodiment as the above, it does not imply to limit the present invention, any person who is skilled the art could make any change or modification within the spirit and scope of the present invention, however, it is belongs to the scope of the present invention, the protective scope of the present invention is defined by the following claims.

1-19. (canceled)

20. A combo-type male and female USB connector, comprising:
a wrap piece;
a metallic shell with a first end and a second end, the first end being a free end and the second end being placed in the wrap piece; and
an electrically connecting terminal board, providing a plurality of electrically connecting terminals, an inner end thereof being placed in the wrap piece and an outer end thereof being disposed in the metallic shell and at the first end of the metallic shell;
characterized in that the metallic shell is movable and the electrically connecting terminal board keeps unmoved such that the electrically connecting terminals is exposed completely to allow the USB connector acting as a male USB connector in case of the metallic shell moving into the wrap piece and the electrically connecting terminals is shielded completely to allow the USB connector acting as a female USB connector in case of the metallic shell moving outward from the wrap piece.

21. The combo-type male and female USB connector according to claim 20, wherein the metallic shell moves against elastic force provided with an elastic device in the wrap piece during exposing the electrically connecting terminals.

22. The combo-type male and female USB connector according to claim 20, wherein the metallic shell is moved with a slide piece sliding along a guide groove at a lateral side of the wrap piece.

23. A combo-type male and female USB connector, comprising:
a wrap piece;
a metallic shell with a first end and a second end, the first end being a free end and the second end being placed in the wrap piece; and
an electrically connecting terminal board, providing a plurality of electrically connecting terminals, an inner end thereof being placed in the wrap piece and an outer end thereof being disposed in the metallic shell and at the first end of the metallic shell;
characterized in that the electrically connecting terminal board is movable and the metallic shell keeps unmoved such that the electrically connecting terminals are exposed completely to allow the USB connector acting as a male USB connector in case of the electrically connecting terminal board being moved away the metallic shell and the electrically connecting terminals are shielded completely to allow the USB connector acting as a female USB connector in case of the electrically connecting terminal board being moved into the metallic shell.

24. The combo-type male and female USB connector according to claim 23, wherein the electrically connecting terminal board is moved by means of a slide moving along a guide groove provided either at the top or at the bottom of the wrap piece.

25. A combo-type male and female USB connector, comprising:
a wrap piece;
a metallic shell with a first end and a second end, the first end being a free end and the second end being placed in the wrap piece; and
an electrically connecting terminal board, providing a plurality of electrically connecting terminals, an inner end thereof being placed in the wrap piece and an outer end thereof being disposed in the metallic shell and at the first end of the metallic shell;
characterized in that the metallic shell is composed of two metallic shell halves with one of the metallic shell halves being movable and pivotally connected to the front end of the wrap piece at the second end thereof and the other metallic shell half being fixedly attached to the front end of the front end of the wrap piece and the electrically connecting terminal board keeps unmoved such that the electrically connecting terminals are exposed completely to allow the USB connector acting as a male USB connector in case of the movable metallic shell half being rotationally moved away the other metallic shell half till reaching a position perpendicular to the electrically connecting terminal board and the electrically connecting terminals is shielded completely to allow the USB connector acting as a female USB connector in case of the movable metallic shell half being moved back to join the other metallic shell half.

26. The combo-type male and female USB connector according to claim 25, wherein the front end of the wrap piece has a recess at the top thereof to accommodate the movable metallic shell half.

27. A combo-type male and female USB connector, comprising:
a wrap piece;
a metallic shell with a first end and a second end, the first end being a free end and the second end being placed in the wrap piece; and
an electrically connecting terminal board, providing a plurality of electrically connecting terminals, an inner end thereof being placed in the wrap piece and an outer end thereof being disposed in the metallic shell and at the first end of the metallic shell;
characterized in that the metallic shell is composed of two movable metallic shell halves with the second thereof being pivotally connected to the front end of the wrap piece and the electrically connecting terminal board keeps unmoved such that the electrically connecting terminals are exposed completely to allow the USB connector acting as a male USB connector in case of the movable metallic shell halves being rotationally moved away the electrically connecting terminal board till the movable metallic shell halves being lined up and crossing the electrically connecting terminal board and the electrically connecting terminals are shielded completely to allow the USB connector acting as a female USB connector in case of the movable metallic shell halves being moved back to join with each other.

28. The combo-type male and female USB connector according to claim 27, wherein the front end of the wrap piece has a recess to accommodate the two metallic shell halves.
